(19) United States
(12) Patent Application Publication
(10) Pub. No.: US 2018/0081951 A1
(43) Pub. Date: Mar. 22, 2018

(54) INFORMATION GENERATION SYSTEM, A METHOD AND A NON-TRANSITORY COMPUTER READABLE MEDIUM THEREOF

(71) Applicant: Kabushiki Kaisha Toshiba, Minato-ku (JP)

(72) Inventors: Akira KURODA, Yokohama (JP); Hidenori Matsuzaki, Tokyo (JP); Xinxiao Li, Yokohama (JP); Mayuko Koezuka, Tokyo (JP); Nobuaki Tojo, Yokohama (JP)

(73) Assignee: Kabushiki Kaisha Toshiba, Minato-ku (JP)

(21) Appl. No.: 15/443,104

(22) Filed: Feb. 27, 2017

(30) Foreign Application Priority Data
Sep. 16, 2016 (JP) 2016-181169

(51) Int. Cl. G06F 17/30; G06F 11/36

(52) U.S. Cl. CPC G06F 17/30554; G06F 11/3664; G06F 17/3056; G06F 17/30477

(57) ABSTRACT

According to one embodiment, an information generation system includes an acquisition device, a selection condition reception device, and a generator. The acquisition device acquires a plurality of records. Each record represents a correspondence relationship between at least one setting condition and at least one processing result. The selection condition reception device receives a first segment of one of the at least one setting condition and the at least one processing result, as a first selection condition. The generator extracts records matched with the first selection condition from the plurality of records, and generates a display information to display an image. The image represents an object based on the number of records included in a second segment of another of the at least one setting condition and the at least one processing result, among the records extracted.

### CROSS-REFERENCE TO RELATED APPLICATION

This application is based upon and claims the benefit of priority from Japanese Patent Application No. 2016-181169, filed on Sep. 16, 2016; the entire contents of which are incorporated herein by reference.

### FIELD

Embodiments described herein relate generally to an information generation system, a method and a non-transitory computer readable medium thereof.

### BACKGROUND

As a tool to support a software-test, a system to visually represent a processing result of a software (program) for a certain setting condition is utilized. For example, a system to display a time-line drawing an activity-level during executing the program is proposed.

However, when a relationship between the setting condition and the processing result is displayed, if the number thereof is too many, it is difficult to display the relationship. Furthermore, the relationship is displayed with low visibility.

### BRIEF DESCRIPTION OF THE DRAWINGS

FIG. 1 is a block diagram of a functional component of an information generation system according to a first embodiment.

FIG. 2 is a hardware component of the information generation system.

FIG. 3 is an internal component of an information processing terminal and a server.

FIG. 4 is an example of a record set.

FIG. 5 is one example of a display image according to the first embodiment.

FIG. 6 is another example of the display image according to the first embodiment.

FIG. 7 is a flow chart of processing by the information generation system according to the first embodiment.

FIG. 8 is a flow chart of processing by the information generation system according to a modification 1 of the first embodiment.

FIGS. 9A, 9B and 9C are an example of transition of the display image according to the modification 1 of the first embodiment.

FIG. 10 is one example of the display image according to a modification 3 of the first embodiment.

FIG. 11 is another example of the display image according to the modification 3 of the first embodiment.

FIG. 12 is a block diagram of a functional component of the information generation system according to a second embodiment.

FIG. 13 is a flow chart of processing by the information generation system according to the second embodiment.

### DETAILED DESCRIPTION

According to one embodiment, an information generation system includes an acquisition device, a selection condition reception device, and a generator. The acquisition device acquires a plurality of records. Each record represents a correspondence relationship between at least one setting condition and at least one processing result. The selection condition reception device receives a first segment of one of the at least one setting condition and the at least one processing result, as a first selection condition. The generator extracts records matched with the first selection condition from the plurality of records, and generates a display information to display an image. The image represents an object based on the number of records included in a second segment of another of the at least one setting condition and the at least one processing result, among the records extracted.

Various embodiments will be described hereinafter with reference to the accompanying drawings.

### The First Embodiment

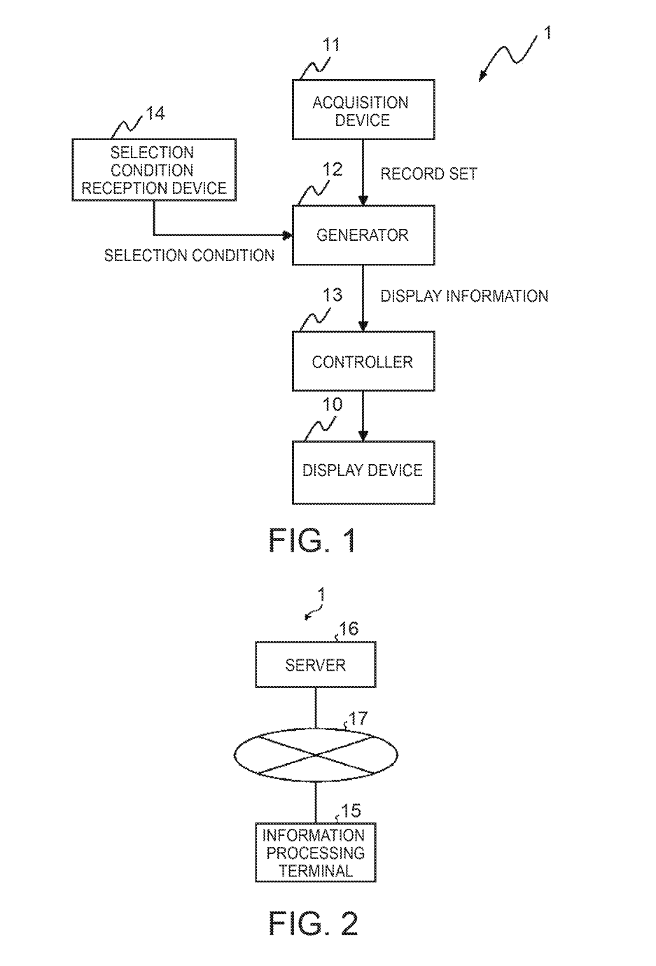

FIG. 1 is a block diagram of a functional component of an information generation system 1 according to the first embodiment. The information generation system 1 is a system to generate information related to processing of a target module.

The target module is a module to output a certain processing result for a certain setting condition, e.g., a hardware to execute a predetermined operation processing by IC (Integrated Circuit), or a software (program) to control a processor.

As a processing of the target module, for example, a test processing is imagined. The test processing is processing to acquire information to decide whether the target module suitably executes the processing. By the test processing, a correspondence relationship between a setting condition and a processing result is acquired. The setting condition is information related to component of the target module, and so on. If the target module is the hardware, for example, the number of cores, the memory capacity, an operational frequency of the core, and so on, can be the setting condition. If the target module is the software, for example, the number of sleds, the number of options, and so on, can be the setting condition.

The processing result is information representing execution of the target module or a simulation result. If the target module is the hardware, for example, an output value (operation result) by execution or simulation, power consumption, the number of memory-accesses, an execution performance value, and so on, can be the processing result. If the target module is the software, for example, an output value by execution or simulation, an execution performance value, and so on, can be the processing result.

By executing the test processing multiple times with changing the setting condition, a plurality of correspondence relationships can be acquired. A concrete method for executing the test processing is not limited. Any conventional method used for a performance test or a function test can be utilized. Further, processing of the target module is not limited to the test processing. For example, it may be processing at normal timing of the target module. In following embodiments, the case that processing of the target module is test processing is explained.

An information processing system 1 includes a display device 10, an acquisition device 11, a generator 12, a controller 13, and a selection condition reception device 14. The display device 10 is, for example, a display of a computer.

The acquisition device 11 acquires a record set representing a correspondence relationship between a set condition and a processing result for each test processing. The correspondence relationship is acquired from the test processing result. The record set will be explained afterwards by referring to FIG. 4. The acquisition device 11 is composed by, for example, a CPU (Central Processing Unit), a program controlling the CPU, a logical circuit, and so on.

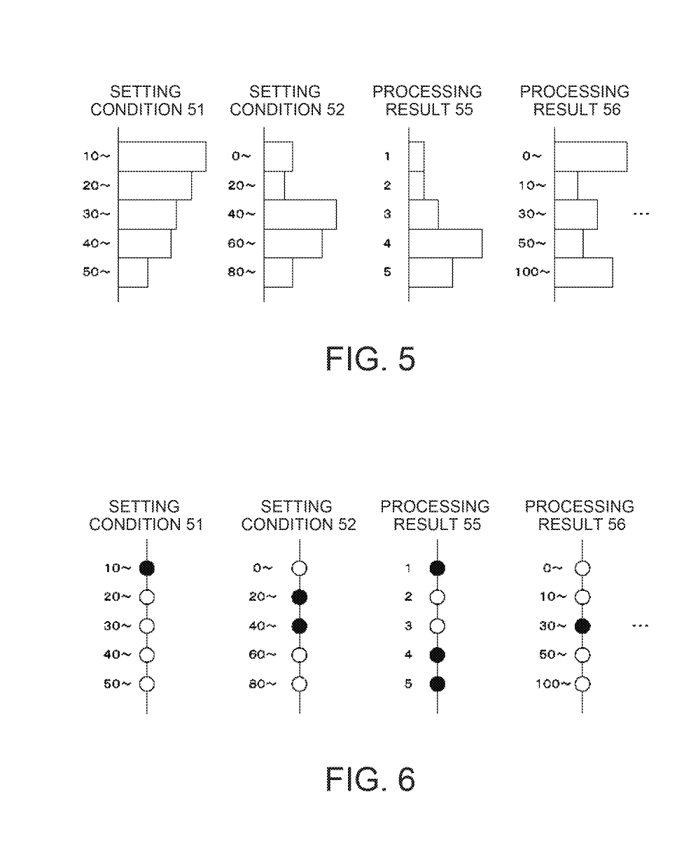

The generator 12 generates display information to generate a display image visually representing the correspondence relationship of each test processing, based on the record set. The display image will be explained afterwards by referring to FIGS. 5 and 6. Furthermore, the generator 12 can also generate the display information, based on the record set and the selection condition acquitted by the selection condition reception device 14. The generator 12 is composed by, for example, a CPU, a program controlling the CPU, a logical circuit, and so on.

The controller 13 controls the display device to display the display image, based on the display information generated by the generator 12. The controller 13 is composed by, for example, a CPU, a program controlling the CPU, a logical circuit, and so on.

The selection condition reception device 14 selects at least one setting condition (or at least one processing result) from setting conditions (or processing results) included in the record set. For example, based on a user's selection operation, the selection condition reception device 14 selects the setting condition or the processing result.

FIG. 2 is a hardware component of the information generation system 1. The information generation system 1 includes an information processing terminal 15, a server 16, and a network 17. The information processing terminal 15 is a PC (Personal Computer), a tablet, and a smart-phone, and so on. The server 16 is a server computer managed by a manager of the information generation system 1. The information processing terminal 15 and the server 16 are connected via the network 17 such as an Internet. The server 16 preferably composes at least one part of the generator 12 (executes at least one part of processing to generate the display information). Furthermore, the display device 10 to display the display image is preferred as a display of the information processing terminal 15. The selection condition reception device 14 may be realized by any of the information processing terminal 15 and the server 16. For example, by receiving a user's operation from the information processing terminal 15, the setting condition or the processing result may be selected. Alternatively, based on information stored in the server 16, the setting condition or the processing result may be selected.

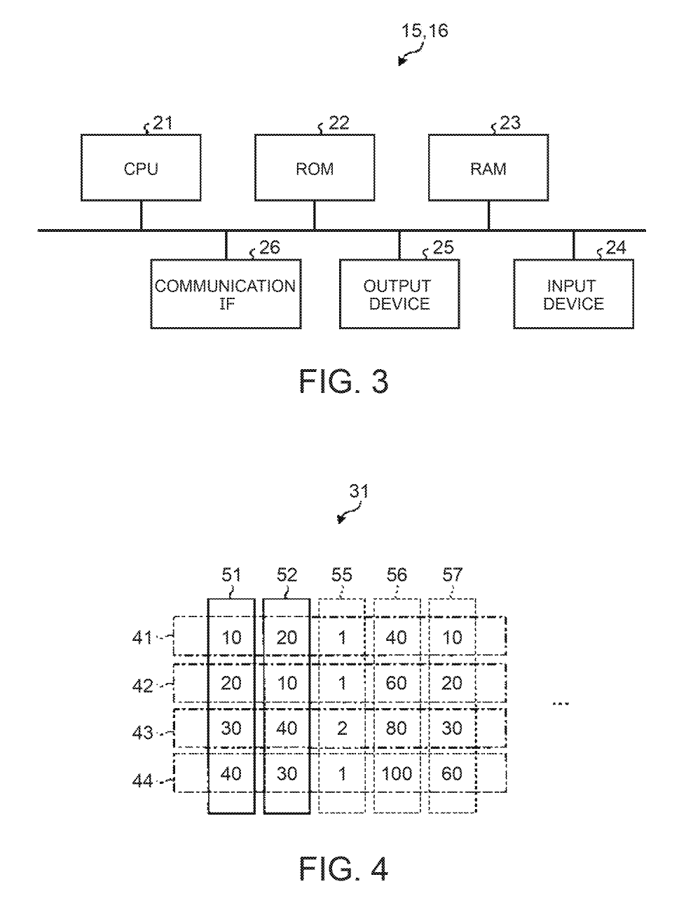

FIG. 3 is an internal component of the information processing terminal 15 and the server 16. The information processing terminal 15 and the server 16 include a CPU 21, a ROM (Read Only Memory) 22, a RAM (Read Access Memory) 23, an input device 24, an output device 25, and a communication IF (Interface) b 26. The CPU 21 executes predetermined operation processing using the RAM 23 as a working area, based on a program stored in the ROM 22. The input device 24 is a device to input information from the outside, for example, a keyboard, a mouse, a touch panel, and so on. The output device 25 is a device to output information (generated in the inside) to the outside, for example, a display, a printer, and so on. The communication IF 26 is a device able to transmit/receive information with an apparatus of the outside via the network 17.

Here, the hardware component shown in FIGS. 0.2 and 3 are one example. The information generation system 1 can be realized by various hardware components. For example, the display device 10, the acquisition device 11, the generator 12, the controller 13 and the selection condition reception device 14, can be realized by a general purpose computer (as a single unit), a dedicated device incorporating a processor, and so on.

Furthermore, by connecting a plurality of computers via an Intranet, the display device 10, the acquisition device 11, the generator 12, the controller 13 and the selection condition reception device 14, can be realized. For example, by connecting the server 16 and a plurality of information processing terminals 15 via the network 17, the information processing terminal 15 realizing the display device 10 and the controller 13 may be different from the information processing terminal 15 realizing the selection condition reception device 14.

Furthermore, in FIG. 1, most basic functional blocks (the display device 10, the acquisition device 11, the generator 12, the controller 13, the selection condition reception device 14) of the information generation system 1 are connected in order of the processing. However, the embodiment is not limited to this component. For example, a component that each functional block cooperatively operates in parallel, a component that order of each functional block is replaced, a component that one functional block is divided into a plurality of functional blocks, or a component that these three components are combined, may be used.

A program to realize function of the information generation system 1 can be provided by being recorded into a computer-readable recording medium (such as a CD-ROM, a flexible disk (FD), a CD-R, a DVD, and so on) as a file having installable format or executable format. Furthermore, the program may be provided by being downloaded from a predetermined memory device (connected to a network) to a predetermined computer, or may be provided to a predetermined information processing device by previously being incorporated into the ROM. Furthermore, the program may be composed by a plurality of modules to realize each function of the acquisition device 11, the generator 12, the controller 13 and the selection condition reception device 14.

Furthermore, each function of the acquisition device 11, the generator 12, the controller 13 and the selection condition reception device 14 may be realized by the CPU 21 executing the program, may be realized by function of hardware of IC, or may be realized by combination use thereof.

FIG. 4 is an example of a record set 31. The record set 31 of this example includes a first record 41, a second record 42, a third record 43 and a fourth record 44. Each record 41˜44 represents a correspondence relationship between setting conditions 51˜52 and processing results 55˜57 in one test processing. Each record 41˜44 of this example includes a first setting condition 51, a second setting condition 52, a first processing result 55, a second processing result 56 and a third processing result 57. Namely, in one test processing of this example, in response to inputs of two setting conditions 51 and 52, three processing results 55˜57 are acquired.

The setting conditions 51˜52 and the processing results 55˜57 are divided by each type. For example, a type of the first setting condition 51 is “the number of cores”, and a type of the second setting condition 52 is “memory capacity”. Here, in the first record 41, a concrete value of the first setting condition 51 (the number of cores) is “10”, and a concrete value of the second setting condition 52 (memory capacity) is “20”. Furthermore, a type of the first processing result 55 is “output value”, a type of the second processing result 56 is “power consumption”, and a type of the third processing result 57 is “the number of memory-accesses”. Here, in the first record 41, a concrete value of the first processing result 55 (output value) is “1”, a concrete value of the second processing result 56 (power consumption) is “40”, and a concrete value of the third processing result 57 (the number of memory-accesses) is “10”. Further, the concrete value is not limited to a numerical value. For example, it may be a character, or a sign.

FIGS. 5 and 6 are one example of a display image. In the first embodiment, for example, as shown in FIGS. 5 and 6, the setting condition and the processing result are displayed. However, if the number of setting conditions or the number of processing results) is many, and if points corresponding to all setting conditions and all processing results are plotted, the visibility is degraded. Accordingly, by segmenting the setting condition and the processing result respectively, an object is displayed based on the number of records included in each segment or existence/non-existence of record included in each segment. As a bar of bar graph in FIG. 5 and a plotted point in FIG. 6, a figure displayed in proportion to the number of records included in a segment is called “an object”.

FIG. 5 is one example of a display image that the number of records included in each segment (by segmenting the setting condition and the processing result respectively) is represented as a bar graph. The setting condition 51 in FIG. 5 is segmented into “larger than (or equal to) 10 and smaller than 20”, “larger than (or equal to) 20 and smaller than 30”, “larger than (or equal to) 30 and smaller than 40”, “larger than (or equal to) 40 and smaller than 50”, “larger than (or equal to) 50”, and the number of records included in each segment is displayed. Each segment may not be determined as a range of value. For example, as shown in the processing result 55 of FIG. 5, each segment may be determined as a single value. Furthermore, if the setting condition and the processing result are represented by a character or a sign, each segment may be determined as the character or the sign. Furthermore, each segment may not be equally divided. As shown in the processing result 56 of FIG. 5, a range of each segment may be different. A range of one segment may be wider or narrower than a range of another segment.

FIG. 6 is one example of a display image that existence/non-existence of records included in each segment (by segmenting the setting condition and the processing result respectively) is represented. For example, if at least one record is included in a segment, an object of black circle is displayed. If no records are included in a segment, an object of white circle is displayed.

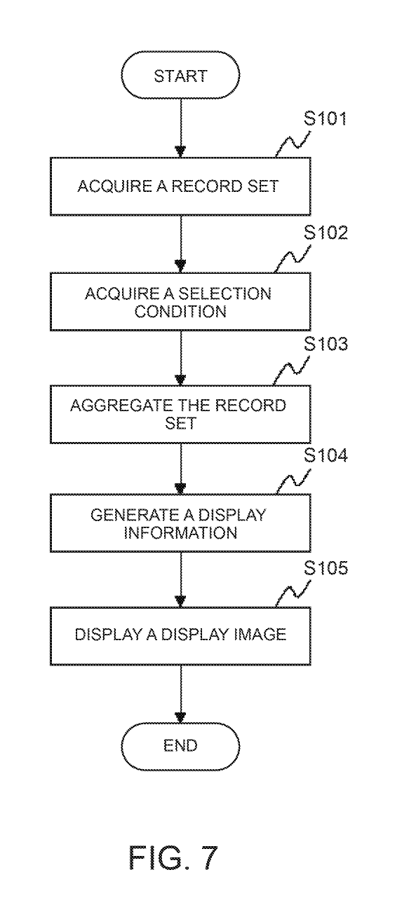

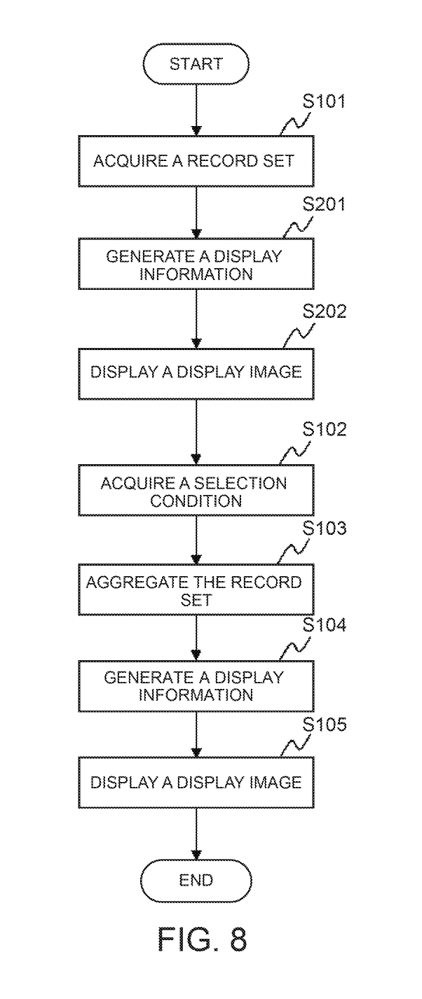

FIG. 7 is a flow chart of processing by the information generation system 1 according to the first embodiment. First, the acquisition device 11 acquires a record set 31 (S101). This acquisition processing is performed by a suitable method using an apparatus included in adopted hardware component. For example, the server 16 receives data related to the record set 31 from the information processing terminal 15 via the network 17. Furthermore, the server 16 receives data from another information processing terminal not shown in FIG. 2, or data is inputted to the server 16 directly.

Next, the selection condition reception device 14 acquires a selection condition (S102). As the selection condition, not only the setting condition but also the processing result may be selected. Furthermore, a range of value such as “the setting condition 51 is included in a range 10˜20” may be set, or one value such as “the setting condition 51 is 10” may be set. If the setting condition or the processing result is represented as a character or a sign (e.g., “A”, “B”), the selection condition may be set as the character or the sign. In following explanation, as an example, a selection condition “the setting condition 51 is included in a range 10˜20” is acquired.

Next, based on the record set 31 and the selection condition, the generator 12 aggregates the record set (S103). In order to aggregate the record set 31, first, records matched with the selection condition are extracted from the record set 31. Then, among the extracted records, the number of records is counted for each segment of the setting condition and the processing result. Further, as shown in FIG. 6, if existence/non-existence of records included in each segment is displayed, among the extracted records, existence/non-existence of records is decided for each segment of the setting condition and the processing result.

Then, the generator 12 generates display information (S103). The display information is information to generate a display image, e.g., information specifying an axis of setting condition, an axis of processing result, a display position of object, a size of object, and so on. Next, by the controller 13 controlling the display device 10 (for example, a display of the information processing terminal 15) based on the display information, the display image is displayed on the display device 10 (S104).

As mentioned-above, in the information generation system 1 of the first embodiment, by acquiring a selection condition from the setting condition or the processing result, records matched with the selection condition are extracted and displayed. Accordingly, even if the number of setting conditions or processing results is many, records matched with a condition noticed by a user can be displayed, and visibility for the user improves. Furthermore, in the information generation system 1, a plurality of setting conditions and a plurality of processing results can be displayed as one graph collectively. Accordingly, the user can easily understand a relationship between the setting condition and the processing result.

Hereinafter, modifications of the first embodiment will be explained. The modifications can be used by being combined.

(Modification 1)

FIG. 8 is a flow chart of processing by the information generation system 1 according to a modification 1 of the first embodiment. In the information generation system 1, before acquiring the selection condition, a display image may be generated based on all records acquired (S201) and displayed on the display device 10 (S202).

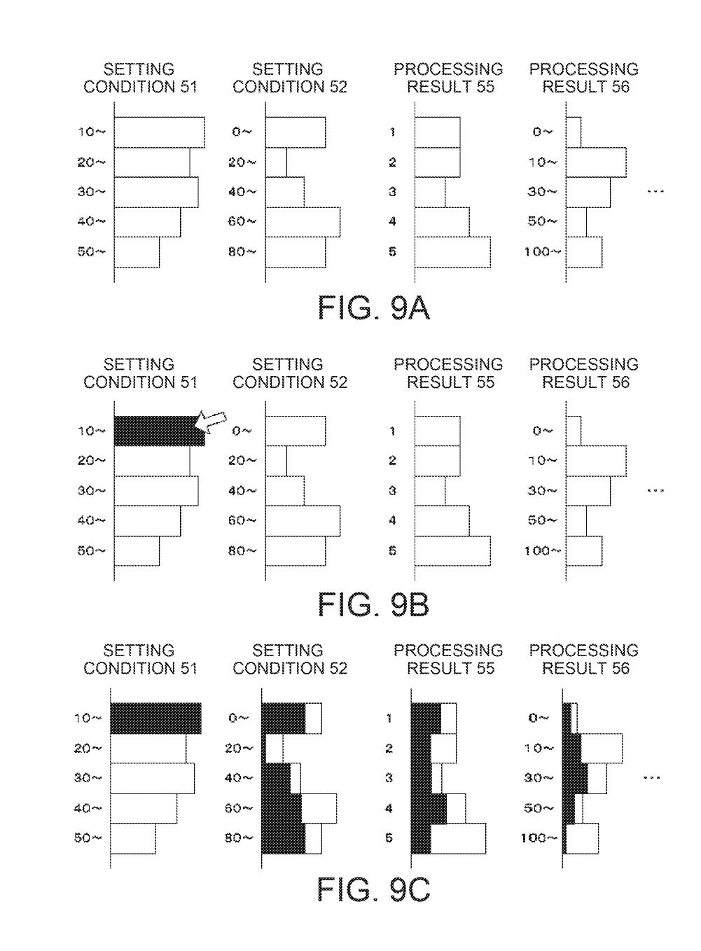

FIGS. 9A, 9B and 9C are an example of screen-transition of a display image when processing based on the flow chart of FIG. 8 is performed. As shown in FIG. 9A, the display image based on all records is displayed on the display device 10. Then, a part of the setting condition or the processing result is selected as a selection condition by a user's operation. In FIG. 9B, one segment of the setting condition 51 is selected using a pointer. Here, as shown in FIG. 9C, a record set extracted (based on the selection condition) and aggregated by the generator 12 is displayed on the display device 10.

In the example of FIG. 9B, one segment of the setting condition 51 is selected as the selection condition. However, a method for selecting the selection condition is not limited to this. The selection condition may be indicated as a segment having a range different from the displayed segment. For example, in FIG. 9A, a first segment of the setting condition 51 is “larger than (or equal to) 10 and smaller than 20”, and a second segment of the setting condition 51 is “larger than (or equal to) 20 and smaller than 30”. Contrary to this, a segment such as “setting condition 51 is larger than (or equal to) 12 and smaller than 27” may be indicated.

In the example of FIG. 9C, a record set before extracting records matched with the selection condition therefrom is displayed by overlapping with records matched with the selection condition after extracting the records. However, the method for displaying is not to this. After selecting the selection condition, the record set before extracting records matched with the selection condition may not be displayed. Only the records matched with the selection condition after extracting may be displayed.

(Modification 2)

In flow charts of FIGS. 7 and 8, after the display image is displayed on the display device 10 (S105), a selection condition may be newly acquired. The generator 12 aggregates the record set using the selection condition (newly acquired), and generates display information. Then, based on the display information (newly generated), the controller 13 controls the display device 10 to display a display image.

By deleting the selection condition (already acquired) and by using a selection condition (newly acquired) only, the generator 12 may extract a record set and aggregate it. The generator 12 may extract a record set matched with both the selection condition (already acquired) and the selection condition (newly acquired), and aggregate it (AND of selection condition). The generator 12 may extract a record set matched with at least one of the selection condition (already acquired) and the selection condition (newly acquired), and aggregate it (OR of selection condition). Furthermore, by acquiring a plurality of selection conditions, the generator 12 may use them combined with AND-operation or OR-operation.

The plurality of selection conditions may be acquired from the same setting condition or the same processing result. Furthermore, the plurality of selection conditions may be acquired from different setting conditions or different processing results. For example, a first selection condition may be selected from the setting condition 51, and a second selection condition may be selected from the processing result 56.

Furthermore, by acquiring a plurality of selection conditions at S102 of flow chart in FIG. 7, the record set may be extracted using AND-operation or OR-operation of the plurality of selection conditions, or combination use thereof.

(Modification 3)

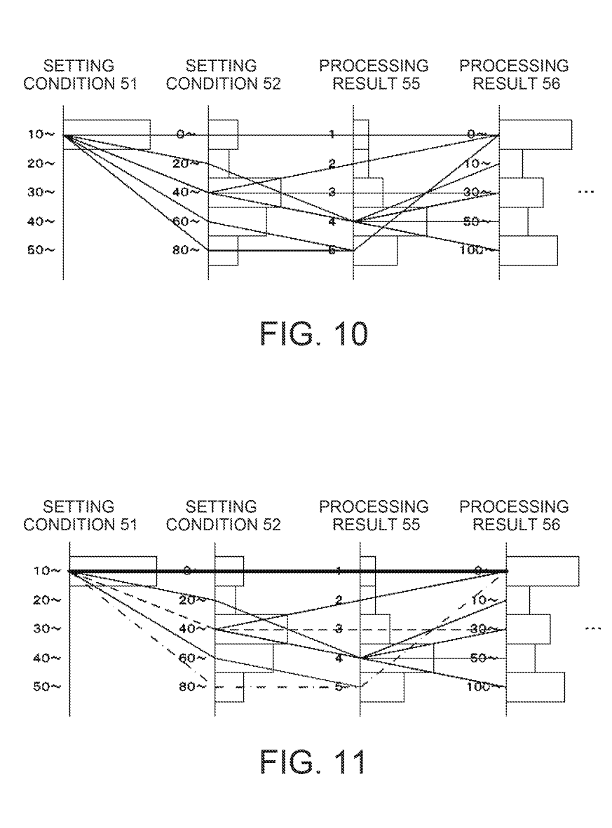

FIG. 10 is one example of the display image generated by the generator 12. As shown in FIG. 10, as for records extracted by the selection condition, a relational object representing combination of the setting condition and the processing result may be displayed. In FIG. 10, as the relational object, a parallel coordinate plot chart representing a line connecting the setting condition and the processing result is shown.

For example, it is assumed that, a first segment of the setting condition 51 is selected as a selection condition. It is assumed that, in one record extracted, a first segment of the setting condition 52, a first segment of the processing result 55, and a first segment of the processing result 56, are included. In this case, on the display image generated by the generator 12, a line connecting the first segment of the setting condition 51, the first segment of the setting condition 52, the first segment of the processing result 55 and the first segment of the processing result 56, are included.

Furthermore, it is assumed that, in one record extracted, a second segment of the setting condition 52, a fourth segment of the processing result 55, and a third segment of the processing result 56, are included. In this case, on the display image generated by the generator 12, a line connecting the first segment of the setting condition 51, the second segment of the setting condition 52, the fourth segment of the processing result 55 and the third segment of the processing result 56, are included.

Furthermore, as shown in FIG. 11, a ratio (of records included in a combination of the setting condition and the processing condition) may be represented by a kind, a thickness or a color of a line representing the combination. The ratio may be a ratio of records (included in the combination) to all records. Alternatively, the ratio may be a ratio of records (included in the combination) to records extracted by the selection condition.

For example, if the number of records included in the combination (each segment) of the setting condition and the processing result is larger than (or equal to) 20% of the number of all records, this relationship is represented by a bold line. If the number of records included in the combination (each segment) of the setting condition and the processing result is larger than (or equal to) 10% and less than 20% of the number of all records, this relationship is represented by a dotted line. In this case, in the example of FIG. 11, it is understood that, records included in the first segment of the setting condition 51, the first segment of the setting condition 52, the first segment of the processing result 55, and the first segment of the processing result 56, occupies larger than (or equal to) 20% among all records.

For example, whether to display these lines, or which ratio is displayed by which line, may be determined in response to the user's operation.

### The Second Embodiment

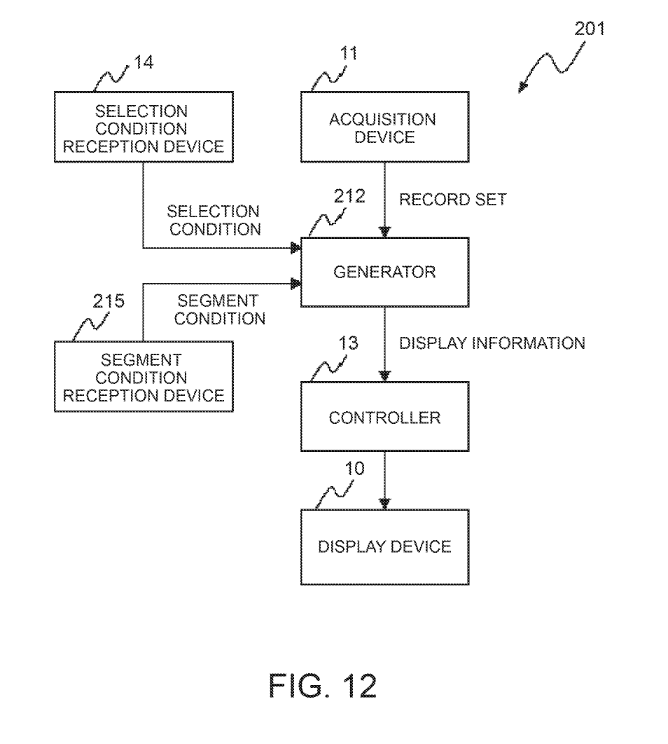

FIG. 12 is a block diagram of component of an information generation system 201 according to the second embodiment. As to the same component as the information generation system 1, the same sign is assigned, and explanation thereof is omitted. The information generation system 201 includes a segment condition reception device 215. In addition to the selection condition inputted from the selection condition reception device 14, a generator 212 generates display information using a segment condition inputted from the segment condition reception device 215.

The segment condition reception device 215 acquires information (Hereafter, it is called “a segment condition”) indicating a range included in the segment of the setting condition or the processing result.

Hardware component of the information generation system 201 is same as hardware component of the information generation system 1. Accordingly, explanation thereof is omitted. The segment condition reception device 215 may be realized by any of the information processing terminal 15 and the server 16. Furthermore, the segment condition reception device 215 may be realized by the CPU 21 executing a program, by function of hardware such as IC, or by combination use thereof.

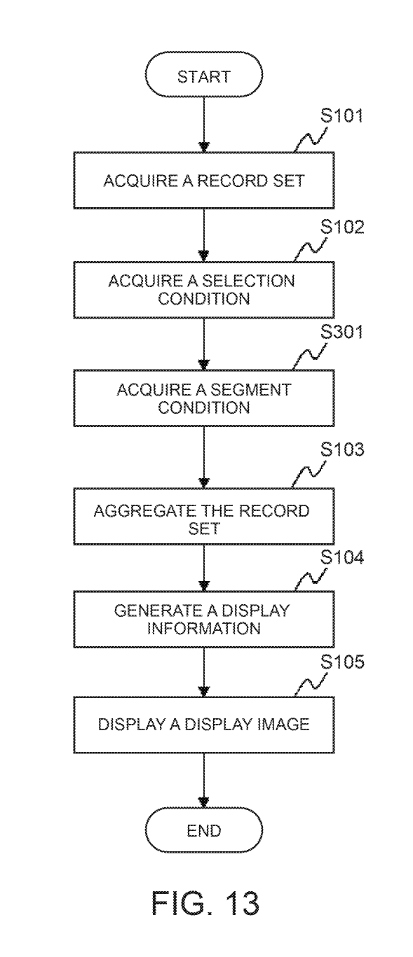

FIG. 13 is a flow chart of processing by the information generation system 201 according to the second embodiment. In the information generation system 201, a segment condition is acquired (S301). As the segment condition, a range of value may be directly indicated, e.g., “a first segment of the setting condition 51 is 0˜100, a second segment thereof is 101˜200, a third segment thereof is 201˜300, . . . ”. Furthermore, the number of division to segment may be indicated, e.g., “the setting condition 51 is divided into five segments”. Furthermore, the setting condition 51 may be indicated as a range of value directly and the setting condition 52 may be indicated as the number of division, i.e., a method for indicating the segment condition may be different for each setting condition or each processing result.

Further, after the display image is displayed on the display device 10 (S105), by receiving a new segment condition by the segment condition reception device 215, display information may be generated based on the new segment condition. As a result, the user can confirm the user's desired setting condition or processing result in detail.

In the second embodiment, modifications explained in the first embodiment can be adopted. By setting the segment condition or the setting condition repeatedly by the user, the user's desired display image can be displayed on the display device 10.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for generating information, comprising:
an acquisition device that acquires a plurality of records, each record representing a correspondence relationship between at least one setting condition and at least one processing result;
a selection condition reception device that receives a first segment of one of the at least one setting condition and the at least one processing result, as a first selection condition; and
a generator that extracts records matched with the first selection condition from the plurality of records, and generates a display information to display an image representing an object based on the number of records included in a second segment of another of the at least one setting condition and the at least one processing result, among the records extracted.

2. The system according to claim 1, wherein
the generator generates the display information to display the object representing existence or non-existence of records included in the second segment, among the records extracted.

3. The system according to claim 1, wherein
the generator generates the display information to display the object representing the number of records included in the second segment, among the records extracted.

4. The system according to claim 1, wherein
the generator generates the display information to display a relational object representing a correspondence relationship between the at least one setting condition and the at least one processing result.

5. The system according to claim 4, wherein
the generator generates the display information to display the relational object by a display method based on the number of records matched with the correspondence relationship represented by the relational object, among the records extracted.

6. The system according to claim 1, further comprising:
a segment condition reception device that receives a segment condition representing a range of the second segment.

7. The system according to claim 1, wherein
the selection condition reception device receives a third segment of the at least one setting condition or the at least one processing result, as a second selection condition,
the generator extracts records matched with both the first selection condition and the second selection condition, and generates a display information to display an object based on the number of records included in the second segment, among the records extracted.

8. The system according to claim 1, wherein
the selection condition reception device receives a third segment of the at least one setting condition or the at least one processing result, as a second selection condition,
the generator extracts records matched with any of the first selection condition and the second selection condition, and generates a display information to display an object based on the number of records included in the second segment, among the records extracted.

9. The system according to claim 1, further comprising:
an information processing terminal used by a user; and
a server connected to the information processing terminal via a network;
wherein
at least one part of processing to generate the display information is executed by the server, and
the image is displayed on a display device of the information processing terminal.

10. The system according to claim 1, wherein
the display information is information to generate an image to display an object representing the at least one setting condition and an object representing the at least one processing result.

11. The system according to claim 1, wherein
the selection condition reception device receives a first segment of the at least one setting condition as a first selection condition,
the generator extracts records matched with the first selection condition from the plurality of records, and generates a display information to display an image representing an object based on the number of records included in a second segment of the at least one processing result and an object based on the number of records included in the first segment, among the records extracted.

12. The system according to claim 1, wherein
the selection condition reception device receives a first segment of the at least one processing result as a first selection condition,
the generator extracts records matched with the first selection condition from the plurality of records, and generates a display information to display an image representing an object based on the number of records included in a second segment of the at least one setting condition and an object based on the number of records included in the first segment, among the records extracted.

13. An apparatus for generating information, comprising:
an acquisition device that acquires a plurality of records, each record representing a correspondence relationship between at least one setting condition and at least one processing result;
a selection condition reception device that receives a first segment of one of the at least one setting condition and the at least one processing result, as a first selection condition;
a generator that extracts records matched with the first selection condition from the plurality of records, and generates a display information to display an image representing an object based on the number of records included in a second segment of another of the at least one setting condition and the at least one processing result, among the records extracted; and
a controller that controls a display device to display the image, based on the display information.

14. A method for generating information by a computer, the method comprising:
acquiring a plurality of records, each record representing a correspondence relationship between at least one setting condition and at least one processing result;
receiving a first segment of one of the at least one setting condition and the at least one processing result, as a first selection condition;
extracting records matched with the first selection condition from the plurality of records; and
generating a display information to display an image representing an object based on the number of records included in a second segment of another of the at least one setting condition and the at least one processing result, among the records extracted.

15. A non-transitory computer readable medium for causing a computer to perform operations for generating information, the operations comprising:
acquiring a plurality of records, each record representing a correspondence relationship between at least one setting condition and at least one processing result;
receiving a first segment of one of the at least one setting condition and the at least one processing result, as a first selection condition;
extracting records matched with the first selection condition from the plurality of records; and
generating a display information to display an image representing an object based on the number of records included in a second segment of another of the at least one setting condition and the at least one processing result, among the records extracted.
